(19) United States
(12) Patent Application Publication
(10) Pub. No.: US 2021/0289194 A1
(43) Pub. Date: Sep. 16, 2021

(54) SYSTEM, METHOD, AND COMPUTER PROGRAM FOR GENERATING VOLUMETRIC VIDEO

(71) Applicant: Amdocs Development Limited, Limassol (CY)

(72) Inventors: Pavel May, Rishon leZion (IL); Vladimir Tkach, Kfar Yona (IL); Sergey Podalov, Herzliya (IL)

(21) Appl. No.: 16/817,287

(22) Filed: Mar. 12, 2020

(51) Int. Cl. H04N 13/388; H04N 13/282

(52) U.S. Cl. CPC H04N 13/388; H04N 13/282

(57) ABSTRACT

As described herein, a system, method, and computer program are provided for generating volumetric video. In use, a system receives, from a plurality of user devices, a plurality of instances of video of an environment. In particular, each instance of the video is captured by a different user device of the plurality of user devices from a perspective of the user device. Further, the system generates a volumetric video using the plurality of instances of video of the environment.

### FIELD OF THE INVENTION

The present invention relates to three-dimensional (3D) video.

### BACKGROUND

Volumetric video is a type of video that captures a three-dimensional (3D) space, such as a location or performance. This type of video can be viewed on flat screens as well as using 3D displays and virtual reality (VR) goggles. However, the viewer, when viewing the video, generally has direct input in exploring the captured 3D space through the video.

Unfortunately, existing solutions for generating volumetric video are limited. To date, a location specifically set up to capture volumetric video has been required, where the location is set up to include numerous cameras surrounding a stage area that will capture, from multiple points of view, live action performed at the stage area. In one specific example, Intel® recently created a stage for volumetric video capture that includes a 10,000 square-feet dome designed to capture actors and objects in volumetric 3D to produce high-end holographic content for VR, augmented reality (AR) and the like.

Due to the inflexible nature of existing solutions to capture volumetric video at only specific locations, these existing solutions have several shortcomings. For example, they cannot provide multiple sources from the most interesting points of views of a spontaneous event or coming from an unplanned place/location, they can only be used to provide coverage for things that happen inside their perimeter, they are very expensive by requiring purchase and set up of the numerous cameras in the preselected location, they require building of infrastructure for video producing, they cannot be used for real time coverage of spontaneous events such as flash-mobs, meetings, demonstrations, and/or public shows, etc.

There is thus a need for addressing these and/or other issues associated with the prior art.

### SUMMARY

As described herein, a system, method, and computer program are provided for generating volumetric video. In use, a system receives, from a plurality of user devices, a plurality of instances of video of an environment. In particular, each instance of the video is captured by a user device of the plurality of user devices from a perspective of the user device. Further, the system generates a volumetric video using the plurality of instances of video of the environment.

### BRIEF DESCRIPTION OF THE DRAWINGS

FIG. 1 illustrates a method for generating volumetric video, in accordance with one embodiment.

FIG. 2 illustrates a system for generating volumetric video, in accordance with one embodiment.

FIG. 3 illustrates a method for generating volumetric video using instances of video capturing a same event and associated metadata, in accordance with one embodiment.

FIG. 4A illustrates a plurality of points of view at which instance of video capture a same event, in accordance with one embodiment.

FIG. 4B illustrates a set of produced volumetric video options provided from a point view with different focus distances and view angles, in accordance with one embodiment.

FIG. 5 illustrates a network architecture, in accordance with one possible embodiment.

FIG. 6 illustrates an exemplary system, in accordance with one embodiment.

### DETAILED DESCRIPTION

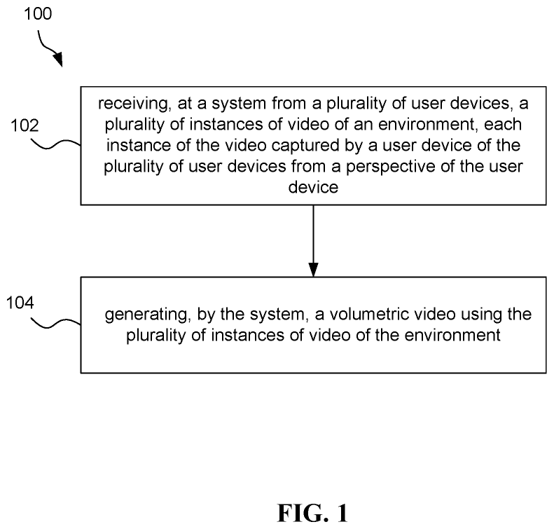

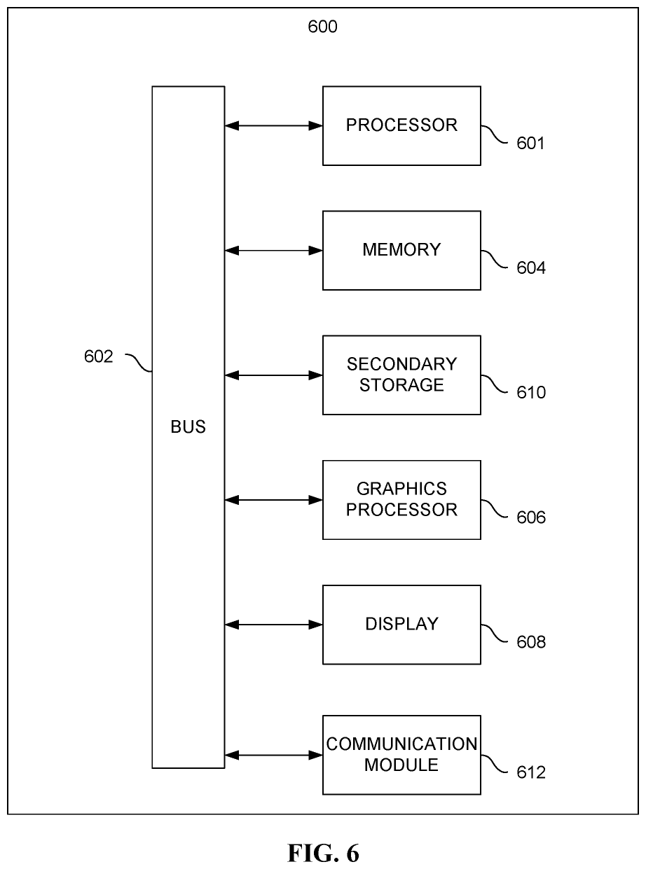

FIG. 1 illustrates a method 100 for generating volumetric video, in accordance with one embodiment. In the context of the present description, the method 100 is performed by a system. The system may be the system of FIG. 6, in one embodiment.

As shown in operation 102, a system receives, from a plurality of user devices, a plurality of instances of video of an environment, where each instance of the video is captured by a user device of the plurality of user devices from a perspective of the user device. The user devices may be devices owned, or at least operated, by different users. For example, the user devices may be mobile phones, tablets, drones, or any other devices capable of being operated by a user to capture video of the environment.

In the context of the present description, the environment refers to a particular location. Accordingly, the plurality of instances of video may be video of the same particular location, optionally captured by the user devices at the same or similar (e.g. overlapping) point in time. For example, the instances of video may each be of a same event occurring within the environment, such as a concert or other performance. As another example, the instances of video may each be of a same scene within the environment, such as a park, building, etc.

As noted above, the instances of video are captured by the user devices from the different perspectives of the user devices. Thus, the user devices may be positioned in different locations to capture the same environment from the different perspectives. The different perspectives may include different rotational orientations of the user devices with respect to (i.e. around) the environment and/or different distances of the user devices from the environment.

Still yet, the system that receives the instances of the video may be a central server or any other computer system remote from the user devices. The system may receive the instances of the video over a network either directly or indirectly from the user devices. For example, the user devices may stream, upload, or in any other manner communicate the instances of the video to the system. In an embodiment, the user devices may each communicate an instance of the video as live video (as the video is being captured) and/or as previously recorded video.

The instances of the video may be received by the system in a common format specified by the system. Thus, each user device may convert, if necessary, the captured video of the environment to the common format before communicating the video to the system. Of course, in another embodiment, an intermediate system communicatively coupled between the system and the user devices may convert, if necessary, the instances of video to the common format before forwarding the video to the system. Further, the instances of video received by the system may be encrypted (e.g. by the user devices or intermediate system), for reducing a size thereof and/or protecting the content thereof.

As another option, the system may convert, if necessary, the instances of video to the common format upon receipt thereof. The system may also decrypt the instances of video, if needed, upon receipt thereof. In any case, the instances of the video may be received by the system in a manner that allows them to be used for generating a volumetric video of the environment, as described in more detail below.

Further, as shown in operation 104, the system generates a volumetric video using the plurality of instances of video of the environment. In the context of the present description, the volumetric video is an interactive video that presents an environment in 3-dimensions (3D). The interactive feature of the volumetric video involves, at the very least, allowing a consumer (viewer) of the volumetric video to change perspectives from which the environment is viewed.

In one embodiment, the volumetric video enables the consumer to select a point of view from which to view the environment within the volumetric video. The point of view may be selected by arrows on a device presenting the volumetric video, device gestures for a device presenting the volumetric video, user movement with respect to a user worn device presenting the volumetric video, etc.

As an option, each available point of view from which the consumer can view the environment within the volumetric video may correspond to one of the perspectives of the user devices from which an instance of the video of the environment was received. As noted above, these perspectives may each include a particular rotational orientation of the user device with respect to the environment and/or a distance of the user device from the environment. Thus, the volumetric video may provide the consumer with a 360 degree view of the environment surrounding the selected point of view, as well as different options for zooming in or out with respect to the environment.

As noted above, the volumetric video is generated using the plurality of instances of video of the environment. A video processing component of the system may process the instances of video according to an algorithm to generate the volumetric video. In an embodiment, artificial intelligence/machine learning may be employed by the system to process the instances of video and generate the volumetric video. For example, the artificial intelligence/machine learning may be able to infer video of the environment from any other perspectives not captured by the user devices.

Once generated, the system may distribute the volumetric video for consumption by one or more consumers. The system may directly distribute (e.g. stream, etc.) the volumetric video to the consumers, or may distribute the volumetric video to one or more content providers that may then directly distribute the volumetric video to the consumers.

To this end, the method 100 may be used to generate volumetric video of an environment without requiring the environment to be prepared in advance (e.g. within a staged area) with a preplanned set-up of cameras. Instead, the method 100 allows the volumetric video to be generated for any environment by leveraging the user devices of any users having a view of the environment. For example, the method 100 may generate volumetric video for a spontaneous event, planned event, and/or even an unplanned place/location (e.g. flash-mobs, meetings, demonstrations, public shows, etc.) simply by receiving video of the event and/or place/location from multiple different user devices having a view thereof. Further, the volumetric video may be distributed in near real-time with respect to the event and/or a time at which the video is captured (e.g. simultaneously) by the user device of the place/location.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

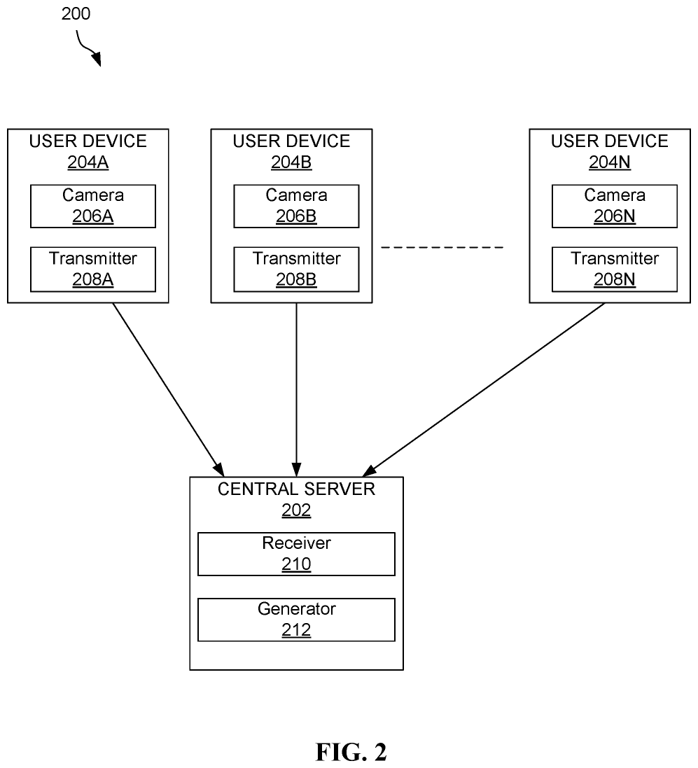

FIG. 2 illustrates a system 200 for generating volumetric video, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, a central server 202 is in communication with a plurality of user devices 204A-N (e.g. over a network, such as the Internet). The user devices 204A-N may be configured to communicate with the central server 202 via a particular address associated with the central server 202. As a further option, the user devices 204A-N may be configured to include an application (e.g. proprietary application associated with the central server 202) for use in communicating with the central server 202.

Each user device 204A-N includes a camera 206A-N. The camera 206A-N is operable to capture (e.g. record) at least video of an environment from a perspective of the corresponding user device 204A-N. The camera 206A-N may include hardware and/or software for capturing the video. In one embodiment, the camera 206A-N may be operated by a user of the corresponding user device 204A-N. For example, the user of the corresponding user device 204A-N may select when to initiate capture of the video, when to terminate capture of the video, or select any other controls with respect to the video.

Additionally, each user device 204A-N includes a transmitter 208A-N. The transmitter 208A-N is operable to transmit video captured by the camera 206A-N to the central server 202. For example, the transmitter 208A-N may be connected to a network to transmit the video to the central server 202 via the network. The transmitter 208A-N may be hardware and/or software installed on the user device 204A-N, and may transmit the video to the central server 202 directly or through an intermediary device.

In operation, the user devices 204A-N utilize their corresponding camera 206A-N to capture respective instances of video of a same environment either simultaneously or near-simultaneously. The user devices 204A-N then utilize their corresponding transmitter 208A-N to transmit their respective instance of video to the central server 202.

In one embodiment, the user devices 204A-N may have installed thereon an application (not shown) configured to control their corresponding camera 206A-N to capture the video and to then utilize the transmitter 208A-N to transmit the video to the central server 202. The application may be a dedicated application of the central server 202, as an option. For example, the application may be configured to transmit the video to a particular address associated with the central server 202. As another example, the application may be configured to convert the video from a format used by the user device 204A-N to a common format used by the central server 202.

The application may also be user controlled, in one embodiment. For example, the application may include one or more user interfaces to allow a user of the user device 204A-N to control when the video is captured by the camera 206A-N (e.g. via start and stop recording functions). As another example, the application may include one or more user interfaces to allow a user of the user device 204A-N to control when the video is transmitted to central server 202 (e.g. either immediately upon recording or at a later user-selected time).

As shown, the central server 202 includes a receiver 210 operable to receive each of the instances of video (either directly or indirectly) from the user devices 204A-N. The receiver 210 may be connected to a network to receive the instances of video over the network. The receiver 210 may be hardware and/or software installed on the central server 202, and may receive the instances of video directly from the user devices 204A-N or indirectly through an intermediary device.

As further shown, the central server 202 includes a generator 212 operable to generate a volumetric video using the instances of video. The generator 212 may be hardware and/or software installed on the central server 202. As an option, the generator 212 (or another other component of the central server 202) may optionally be operable to perform any required pre-processing operations on one or more of the instances of video as necessary to convert those instances to a format able to be used to generate the volumetric video. In one embodiment, the central server 202 may generate the volumetric video as the instances of video are being received via the receiver 210. In another embodiment, the central server 202 may include storage (not shown) to store the received instances of video for use in generating the volumetric video at a later time.

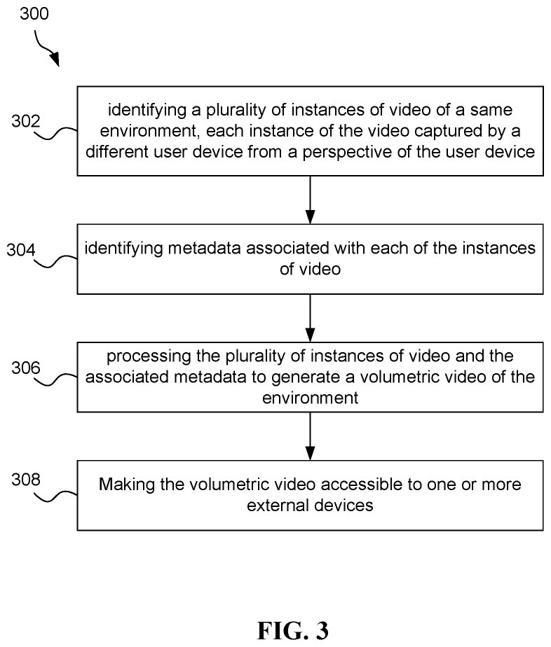

FIG. 3 illustrates a method 300 for generating volumetric video using instances of video capturing a same event and associated metadata, in accordance with one embodiment. The method 300 may be performed in the context of the system 200 of FIG. 2. For example, the method 300 may be performed by the central server 202 of FIG. 2, by way of example.

In operation 302, a plurality of instances of video of a same environment are identified, where each instance of the video is captured by a different user device from a perspective of the user device. The instances of video may be identified upon receipt thereof from the user devices, in one embodiment. In another embodiment, the instances of video may be identified on-demand, or at a particular time after receipt thereof from the user device, for example from a local memory storing the instances of video upon receipt from the user devices.

Additionally, in operation 304, metadata associated with each of the instances of video is identified. In one embodiment, the metadata may be received in association with the plurality of instances of video. For example, each instance of video may be received with metadata from a corresponding user device. As another example, the metadata may be received separately from the associated instance of video but with an identifier of the associated instance of video so that the metadata can be correlated with the instance of video.

The metadata associated with each instance of video may include any data that describes the instance of video and/or the user device that has captured the instance of video. For example, the metadata may indicate a location of the user device (e.g. at a time when the instance of video was captured), where the location is global positioning system (GPS) coordinates of the user device or any other location-identifying information.

As another example, the metadata may indicate an orientation of the user device (e.g. at a time when the instance of video was captured). The orientation may include whether the user device was operating in a landscape mode or a portrait mode. In this way, the orientation may indicate whether the instance of video is formatted in a landscape view or a portrait view. Other examples of the metadata include a view angle of the camera of the user device, a focus distance of the camera of the user device, etc.

As yet another example, the metadata may indicate movement of the user device (e.g. at a time when the instance of video was captured). The movement may refer to a change in location of the user device while the instance of video is being captured. In this way, different portions of the instance of video may be correlated with different locations of the user device, such as based on the indicated movement of the user device and a correlation of a time thereof with a time specified on the instance of video.

Further, as shown in operation 306, the plurality of instances of video and the associated metadata is processed to generate a volumetric video of the environment. For example, the instances of video may be processed based on the associated metadata to generate the volumetric video. In one embodiment, a location indicated by the metadata for an instance of video may be used to include the instance of video, or a processed version thereof, in the volumetric video with respect to that location, so that for example a consumer of the volumetric video can select the location to view that instance of video. This may be similarly applied when different portions of a video are indicated by metadata to be associated with different locations (i.e. movement of the user device that captured the video), such as by including each portion of video in the volumetric video with respect to the location from which the portion of video was captured by the user device. It should be noted that the location may refer to a rotational orientation about the environment and/or or a distance from the environment.

In another embodiment, an indication of the user device orientation indicated by the metadata for an instance of video may be used to perform formatting operations on the instance of video as needed. For example, the formatting operations may provide all instance of video in a same format (e.g. landscape view or portrait view) for further use to generate the volumetric video.

As an option, the volumetric video can be augmented with additional information. The additional information may include, for example, advertisements, statistics, analytics, image and voice recognition, etc.

In one exemplary implementation, the processing in operation 306 may include (1) clustering the instances of video according to the metadata; (2) ranking the instances of video by quality of service; and (3) producing the volumetric video for each cluster.

Moreover, as shown in operation 308, the volumetric video is made accessible to one or more external devices. In one embodiment, the external devices may include the user devices mentioned above. In another embodiment, the external devices may be content provider systems that distribute the volumetric video to consumers (e.g. for use by augmented reality and/or virtual reality devices, regular television boxes, etc.). As a further option, each user of a user device that provides an instance of the video for use in generating the volumetric video may be rewarded according to a volume of the instance of video received and its content quality.

As an option, making the volumetric video accessible in operation 308 may include broadcasting the volumetric video as per preliminary subscribed bundles provided by media delivery services. In various embodiments, subscription bundles may differ by set of view points, by zoom options as per set of provided focus distances, and/or by quality of service.

Table 1 illustrates examples of different subscription bundles.

TABLE 1

Subscription Bundle 1
Active Subscribers: 413
Alternative stream angle: 12
Stream Quality: 4K (4K video resolution)
Streaming time: 11 minutes
Bundle price: $1.99USD per minute
Subscription Bundle 2
Active Subscribers: 13
Alternative stream angle: 10
Stream Quality: 4HD (4 high definition)
Streaming time: 12 minutes
Bundle price: $0.99USD per minute
Subscription Bundle 3
Active Subscribers: 43
Alternative stream angle: 2
Stream Quality: FHD (full high definition)
Streaming time: 24 minutes
Bundle price: $0.99USD per minute
Subscription Bundle 4
Active Subscribers: 3
Alternative stream angle: 12
Stream Quality: HD (high definition)
Streaming time: 21 minutes
Bundle price: $0.10USD per minute

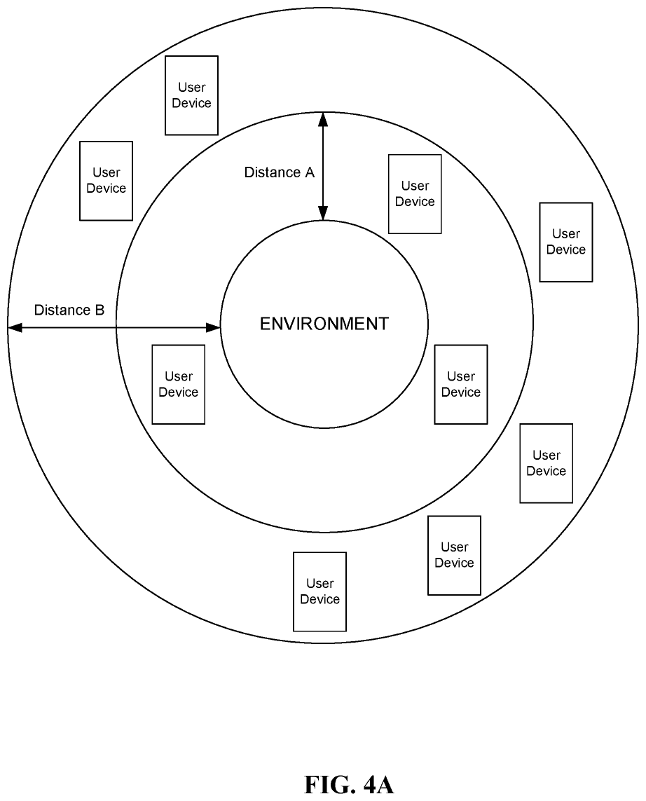

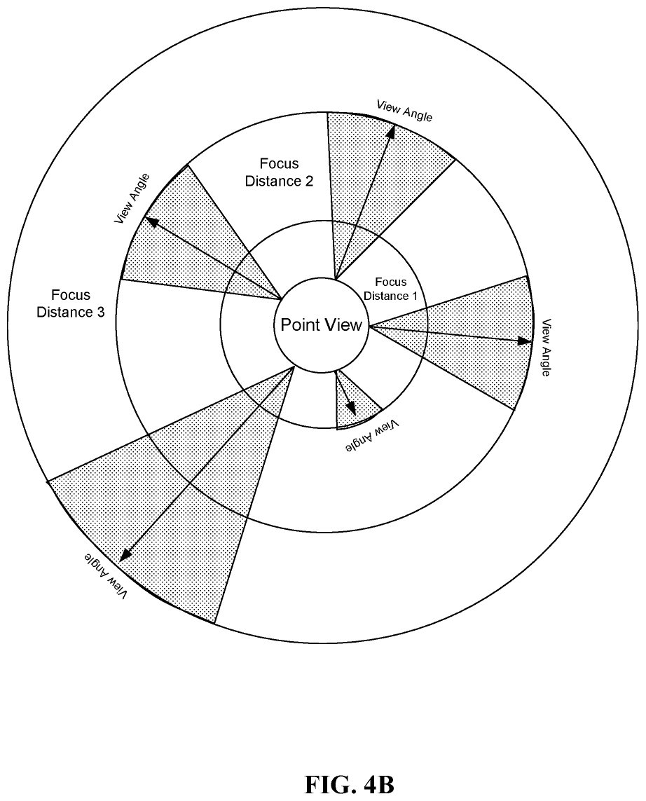

FIG. 4A illustrates a plurality of points of view at which instance of video capture a same event, in accordance with one embodiment.

As shown, a plurality of user devices are situated about a same environment to capture video of the environment. The user devices may be situated at different rotational orientations about the environment, such as some north, south, east, west, etc. of the environment. Further, the user devices may be situated at different distances from the environment (e.g. distances from a center point of the environment). In this way, the user devices may capture video of the environment from different perspectives, including different “sides” (viewing angles) of the environment with different “zoom” (focus distances) into the environment.

FIG. 4B illustrates a set of produced volumetric video options provided from a point view with different focus distances and view angles, in accordance with one embodiment. As shown, the point view can be viewed using volumetric video created for a combination of different focus distances and different view angles. As an option, the view angles may or may not overlap at least in part.

It should be noted that the systems and methods described above may be repeated for multiple different environments (e.g. in proximity to one another), in which case the volumetric videos generated for each of the environments may be combined into a single volumetric videos that allows a consumer to view various environments from selected locations or points of view. This may allow the volumetric video to present an expanded environment that combines all of the different environments with the option for the consumer to view the expanded environment, including specifically the different environments included therein, from the various points of view.

In general, the absolute majority of people participating in public events have smart devices with built-in high-resolution cameras with GPS functionality and a variety of other sensors for accurate device positioning, orientation, movements, etc.

The systems and methods described above suppose usage of a swarm of smart devices that can be applied for transmitting multiple video sources of an outgoing event in real-time. These devices can utilize network high performance to transfer a huge amount of video data in parallel to a processing system.

The video data can be processed in a few ways, such as in real time by computing infrastructure, previously stored and processed at any time to be provided as well as video on demand (VOD), or a combination thereof. The video stream from the devices can be augmented with add-on metadata that enables the generated volumetric data to provide a consumer an ability to choose a desirable point of virtual presence inside the performance location via the volumetric data. Each point of virtual presence can represent a 360-degree panoramic online volumetric video around the selected point.

Thus, a view of the volumetric video can be provided with a feeling of virtual presence inside the performance and can see everything that happens around him in real-time in spite of the fact he is not physically at the location of the performance. As an option, existing stationary video cameras can also be used to enhance a quality of the resulting volumetric video. Further, the smart devices can optionally be mounted on drones or any other mobile object.

Prior solutions for generating volumetric video have several shortcomings, including that they cannot provide multiple sources from the most interesting points of views of an outgoing spontaneous event or coming from an unintended place, they can only be used to provide coverage for things that happen inside their prior staged perimeter, they are very expensive, they require building of infrastructure for video producing, and they cannot be used for real-time coverage of spontaneous events such as flash-mobs, meetings, demonstrations, public shows, etc.

The systems and methods described above, however, resolve the shortcomings of the prior solutions by enabling a large number of sources (e.g. hundreds or thousands) from the most interesting points of views of an outgoing event, enabling coverage for events or environments that happen outside a staged perimeter, being less costly than prior solutions, not requiring the building of infrastructure for video capturing, and being targeted to be for real-time coverage of spontaneous events such as flash-mobs, meetings, demonstrations, public shows, etc.

Exemplary Use Cases

Create volumetric video by leveraging all the live-stream video uploaded by people viewing the event. This allows people not at the event venue to view the event as if they were in various locations of the venue, looking at various angles.

Create volumetric video of traffic in a particular part of the road from car dashboard cams of cars passing by as well as fixed cameras in the area, to be able to study a road accident from multiple angles, walking around the scene looking to understand what happened.

Create volumetric video augmented with partial video coming from a few smart devices (or just one) that are located at the most interesting/critical points of view for the specific event, for example for zooming into specific event zone.

The partial video may be presented as picture in picture (PIP) or for zoom in/out, and can be provided by utilizing artificial intelligence/machine learning algorithms or by a dedicated video editor or producer. This partial video and/or zooming can be selected for full screen viewing by video consumers as per their preferences. Further, the PIP option can be easily monetized by a content service provider (e.g. where the consumer pays as per distance range from event main point and content quality).

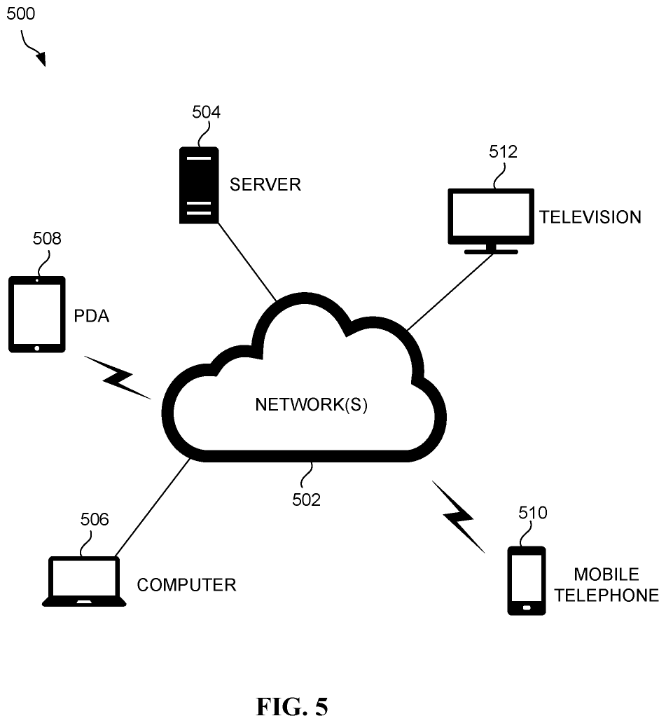

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

Amended claims follow:

1. A non-transitory computer readable medium storing computer code executable by a processor to perform a method comprising:
receiving, at a system from a plurality of user devices, a plurality of instances of video of an environment, each instance of the video captured by a user device of the plurality of user devices from a perspective of the user device;
generating, by the system, a volumetric video using the plurality of instances of video of the environment, wherein the volumetric video presents the environment in 3-dimensions (3D) and includes an interactive feature that allows a viewer of the volumetric video to change perspectives from which the environment is viewed.

2. The non-transitory computer readable medium of claim 1, wherein the user devices include mobile phones.

3. The non-transitory computer readable medium of claim 1, wherein the user devices include drones.

4. The non-transitory computer readable medium of claim 1, wherein the plurality of instances of video are of a same event occurring within the environment.

5. The non-transitory computer readable medium of claim 1, wherein the plurality of instances of video are of a same scene within the environment.

6. The non-transitory computer readable medium of claim 1, wherein the perspective of the user device includes a rotational orientation of the user device with respect to the environment.

7. The non-transitory computer readable medium of claim 1, wherein the perspective of the user device includes a distance of the user device from the environment.

8. The non-transitory computer readable medium of claim 1, further comprising:
receiving, by the system in association with the plurality of instances of video, metadata from the plurality of user devices.

9. The non-transitory computer readable medium of claim 8,
wherein the metadata received from each user device of the plurality of user devices indicates a location of the user device, and wherein the volumetric video is further generated using the metadata.

10. The non-transitory computer readable medium of claim 8, wherein the metadata received from each user device of the plurality of user devices indicates an orientation of the user device.

11. The non-transitory computer readable medium of claim 8, wherein the metadata received from each user device of the plurality of user devices indicates movement of the user device while the user device is capturing the instance of the video, and wherein different portions of an instance of the video having metadata indicating movement of the user device are correlated with different perspectives at different locations and associated times.

12. (canceled)

13. (canceled)

14. The non-transitory computer readable medium of claim 1, wherein each available point of view from which the consumer can view the environment within the volumetric video corresponds to one of the perspectives of the user devices.

15. The non-transitory computer readable medium of claim 14, wherein the perspectives of the user devices each include a rotational orientation of the user device with respect to the environment.

16. The non-transitory computer readable medium of claim 14, wherein the perspectives of the user devices each include a distance of the user device from the environment.

17. The non-transitory computer readable medium of claim 14, wherein the volumetric video provides the consumer with a 360 degree view of the environment surrounding the selected point of view.

18. The non-transitory computer readable medium of claim 1, further comprising:
distributing the volumetric video for consumption by one or more consumers.

19. A method, comprising:
receiving, at a system from a plurality of user devices, a plurality of instances of video of an environment, each instance of the video captured by a user device of the plurality of user devices from a perspective of the user device;
generating, by the system, a volumetric video using the plurality of instances of video of the environment, wherein the volumetric video presents the environment in 3-dimensions (3D) and includes an interactive feature that allows a viewer of the volumetric video to change perspectives from which the environment is viewed.

20. A system, comprising:
a non-transitory memory storing instructions; and
one or more processors in communication with the non-transitory memory that execute the instructions to perform a method comprising:
receiving, from a plurality of user devices, a plurality of instances of video of an environment, each instance of the video captured by a user device of the plurality of user devices from a perspective of the user device;
generating a volumetric video using the plurality of instances of video of the environment, wherein the volumetric video presents the environment in 3-dimensions (3D) and includes an interactive feature that allows a viewer of the volumetric video to change perspectives from which the environment is viewed.

21. The non-transitory computer readable medium of claim 1, wherein at least two of the perspectives of the user devices from which the plurality of instances of video are captured include different distances from the environment that allow the viewer to zoom in or out with respect to the environment.

22. The non-transitory computer readable medium of claim 1, wherein machine learning is used to process the plurality of instances of video to infer additional instances of video of the environment from other perspectives not captured by the user devices.
